(19) United States
(12) Patent Application Publication
(10) Pub. No.: US 2018/0199172 A1
(43) Pub. Date: Jul. 12, 2018

(54) DEVICE AND ARCHITECTURE FOR LOW-POWER NETWORKED COMMUNICATION

(71) Applicant: TECHNOLOGIES RETIA INC., Chambly (CA)

(72) Inventors: Sabin BOILY, Chambly (CA); Sébastien AUCLAIR, Québec (CA)

(73) Assignee: Technologies Retia Inc., Chambly (CA)

(21) Appl. No.: 15/741,269

(22) PCT Filed: Jun. 29, 2016
(86) PCT No.: PCT/CA2016/050764

§ 371 Date: Dec. 31, 2017

Related U.S. Application Data
(60) Provisional application No. 62/188,540, filed on Jul. 3, 2015.

(51) Int. Cl. H04W 4/38; H04W 4/029; H04W 88/16; H04W 4/80; H04W 88/04

(52) U.S. Cl. CPC H04W 4/38; H04W 4/029; H04W 84/18; H04W 4/80; H04W 88/04; H04W 88/16

(57) ABSTRACT

A data communication system includes a plurality of nodes arranged in layers. The system may include at least one sensor node configured to sense a condition and transmit the sensed condition within a first data signal in a wireless short range mode. The system may include a second-layer node configured to transmit a sensed condition within a data signal in a wireless low-power long range communication mode. The system include a first-layer node configured to receive the data signals having the sensed condition, and retransmit the sensed condition in the wireless low-power long range communication mode. The system may further include a networked gateway configured to receive the sensed condition and transmit the sensed condition according to internet protocol.

### CROSS-REFERENCE TO RELATED APPLICATION

The present application claims priority to U.S. provisional application No. 62/188,540, filed on Jul. 3, 2015, and which is incorporated by reference in its entirety.

### FIELD OF THE DISCLOSURE

The present disclosure relates to devices and architecture for low-power network communication, and in particular, for communicating sensed information to a networked gateway.

### BACKGROUND OF THE DISCLOSURE

New technologies are constantly be develop to provide increased connectivity and increased data collection.

### SUMMARY

It would thus be highly desirable to be provided with an apparatus, system or method that would at least partially address the disadvantages of the existing technologies.

The embodiments described herein provide in one aspect a data communication system comprising at least one sensor node configured to sense a condition and transmit the sensed condition within a first data signal in a wireless short range mode, a relay node configured to receive the first data signal transmitted from the at least one sensor node and retransmit the sensed condition within a second data signal in a wireless low-power long range communication mode, and a networked gateway configured to receive the sensed condition from the relay node and transmit the sensed condition according to internet protocol.

The embodiments described herein provide another aspect a data communication system comprising a plurality of second-layer nodes configured to transmit a plurality of sensed conditions within a plurality of data signals in a wireless low-power long range communication mode, and a first-layer node configured to receive the data signals from the second-layer collector nodes, aggregate the sensed conditions of the received data signals, and retransmit the aggregated sensed conditions within an additional data signal in the wireless low-power long range communication mode, and a networked gateway configured to receive the sensed conditions from the first-layer node and transmit the sensed conditions according to internet protocol.

The embodiments described herein provide in yet another aspect a signal communications device comprising a first electronic chip configured to receive first data signals from a plurality of sensor nodes in a first wireless mode and to demodulate the second data signals, and a second electronic chip configured to remodulate the demodulated first data signals to a low-power long range communication mode and transmit the remodulated signals as a second data signal.

### DRAWINGS

The following drawings represent non-limitative examples in which:

FIG. 1 illustrates a schematic diagram of an architecture of a first exemplary low-power communication network;

FIG. 2 illustrates a schematic diagram of an exemplary deployment of the exemplary low-power communication network illustrated in FIG. 1;

FIG. 3 illustrates a block diagram of a low-power communication first-layer node according to one exemplary embodiment;

FIG. 4 illustrates a schematic diagram of an architecture of a second exemplary low-power communication network;

FIG. 5 illustrates a block diagram of a low-power communication collector node according to one exemplary embodiment;

FIG. 6A illustrates a schematic diagram of an interaction between an exemplary sensor node and the exemplary low-power communication relay node;

FIG. 6B illustrates a schematic diagram of an exemplary low-power communication relay node having an embedded sensor;

FIG. 7 illustrates a schematic diagram of an architecture of an exemplary combined low-power communication network;

FIG. 8 illustrates a schematic diagram of an exemplary deployment of the exemplary combined low-power communication network illustrated in FIG. 7;

FIG. 9 illustrates a schematic diagram of an exemplary distribution of nodes within a low-power communication network;

FIG. 10 illustrates a schematic diagram of an exemplary operation of a low-power communication network for a moving vehicle;

FIG. 11 illustrates a schematic diagram of an exemplary operation of a low-power communication network for item tracking;

FIG. 12 illustrates a schematic diagram of presence detector according to exemplary embodiment;

FIG. 13 illustrates a schematic diagram of an exemplary operation of a low-power communication network for presence detection and tracking of vehicles;

FIG. 14 illustrates a schematic diagram of an exemplary application of a low-power communication network for object presence detection and identification;

FIG. 15 illustrates a schematic diagram of an exemplary application of a low-power communication network for tracking the status of a geographic zone;

FIG. 16 illustrates a schematic diagram of an exemplary distribution of a low-power communication network over a given geographic area; and

FIG. 17 illustrates a schematic diagram of another exemplary distribution of a low-power communication network over a given geographic area.

### DESCRIPTION OF VARIOUS EMBODIMENTS

The following examples are presented in a non-limiting manner.

The word “a” or “an” when used in conjunction with the term “comprising” in the claims and/or the specification may mean “one”, but it is also consistent with the meaning of “one or more”, “at least one”, and “one or more than one” unless the content clearly dictates otherwise. Similarly, the word “another” may mean at least a first or more unless the content clearly dictates otherwise.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The terms “coupled” or “coupling” as used herein can have several different meanings depending on the context in which these terms are used. For example, the terms coupled or coupling can have a mechanical or electrical connotation. For example, as used herein, the terms coupled or coupling can indicate that two elements or devices are directly connected to one another or connected to one another through one or more intermediate elements or devices via an electrical element, electrical signal or a mechanical element depending on the particular context.

The term “wireless low-power long range communication mode” (LRLP) as used herein refers to a mode for communicating wirelessly using low power over long distances. The mode includes signal modulation techniques for ensuring data signal transmission on at least the network layer. The mode is long range in that two devices using the mode may maintain signal communication over distances greater than 1 km. For example, signal communication may be maintained over distances greater than 2 km, greater than 5 km, or greater than 10 km. The mode is low-power in that power consumption is kept low during transmission. For example, the current required for transmission is less than 100 mA when transmitting at about 20 dBm or less. In some applications, the current required may be less than 50 mA, or even less than 30 mA when transmitting at 20 dBm or less. To maintain high sensitivity, the data rate in the low-power long-range communication mode may be limited. For example, the sensitivity is better than −120 dBm. For example, the data rate is less than 10 Mbits/sec. In some applications, the data rate may be less than 1 Mbits/sec, such as less than 250 kbits/sec or less than 150 kbits/sec. The low-power long range communication mode may operate on public unlicensed frequency bands, such as the 800 Mhz, 868 MHz, 2.4 GHz or 5 GHz bands. An example of low-power long range communication mode is the operational mode of devices developed for the Long Range Wide-area network (LoRaWAN) standard.

The term “wireless short range mode” herein refers to a mode for communicating wirelessly over a short range. The communication may use low power. The mode includes signal modulation techniques for ensuring data signal transmission on at least the network layer. The mode is short range in that devices using the mode may maintain signal communication over distances less than 1 km. For example, signal communication may be maintained over distances less than 100 m, less than 50 m or less than 10 m. Examples of wireless short range modes include frequency-shift keying (FSK), multiple frequency-shift keying (MFSK), minimum-shift keying, Gaussian frequency-shift key (GFSK), Bluetooth low energy (BLE) but other modulation techniques may also be used.

The term “sensed condition” herein refers to any state of an object or an environmental condition present within a location. The sensed condition may be determined using one or more appropriate sensing or measurement devices.

The term “tracked asset” herein refers to an object or location for which at least one condition of that object or location is to be sensed.

According to exemplary data communication systems described herein, the wireless short-range mode is non-interfering with the wireless low-power long range communication mode.

According to exemplary data communication systems described herein, the at least one sensor node is located in proximity of the relay node.

According to exemplary data communication systems described herein, the at least one sensor node is located less than 100 meters from the relay node.

According to exemplary data communication systems described herein, the first data signal transmitted in the wireless short range mode has a power less than 10 dBm.

According to exemplary data communication systems described herein, the at least one sensor node comprises a plurality of sensor nodes and the relay node is configured to receive conditions sensed the sensor nodes within a plurality of second data signals transmitted in the wireless short range mode and to retransmit the sensed conditions within the first data signal.

According to exemplary data communication systems described herein, the plurality of sensor nodes are located in proximity of one another and the plurality of conditions sensed by the sensor nodes are related to a single tracked asset.

According to exemplary data communication systems described herein, the networked gateway is configured to receive the plurality of sensed conditions and transmit the sensed conditions according to internet protocol to a central node configured to determine a status of the tracked asset based on the sensed conditions.

According to exemplary data communication systems described herein, the low-power long range communication mode is a long range internet-of-things protocol.

According to exemplary data communication systems described herein, the wireless short range mode is chosen from FSK, MSK, GFSK, GMSK or BLE.

According to exemplary data communication systems described herein, the relay node comprises a first electronic chip configured to receive and demodulate the second data signal from the wireless short range mode and a second electronic chip configured to modulate the sensed condition to the low-power long range communication mode and transmit the modulated signal as the first data signal.

According to exemplary data communication systems described herein, the relay node is further configured to adjust a power of the transmitted first data signal.

According to exemplary data communication systems described herein, wherein the relay node is further configured to transmit a control signal in the wireless short range mode to the at least one sensor node.

According to exemplary data communication systems described herein, the relay node further comprises an embedded sensor configured to sense a condition in proximity of the relay node.

According to exemplary data communication systems described herein, the relay node is second-layer node and wherein the system further comprises a first-layer node configured to receive the second data signal from the relay node transmitting in the wireless low-power long range communication mode and retransmit the sensed condition within a third data signal in the wireless low-power long range communication mode and the networked gateway receives the sensed condition within the third data signal from the first-layer collector node.

According to exemplary data communication systems described herein, the second-layer node includes a plurality of second-layer nodes each transmitting in the wireless low-power long range communication mode a second data signal having a sensed condition; and the first-layer node is configured to receive the plurality of second data signals, aggregate the sensed conditions of the first data signals, and retransmit the aggregated sensed conditions within a third data signal in the wireless low-power long range communication mode.

According to exemplary data communication systems described herein, the first-layer node is configured to receive the second data signal at a distance greater than 10 km from the second-layer node and the networked gateway is configured to receive the third data signal at a distance greater than 10 km from the first-layer collector node.

According to exemplary data communication systems described herein, the first-layer node is within line of sight of the networked gateway.

According to exemplary data communication systems described herein, the second-layer node is not within line of sight of the networked gateway.

According to exemplary data communication systems described herein, wherein the first-layer node is located at an elevated position.

According to exemplary data communication systems described herein, the first-layer node is located atop a city building.

According to exemplary data communication systems described herein, the at least one sensor node comprises a first sensor node configured to detect a geographic position of the sensor node as its sensed condition and a second sensor node configured to receive telemetric data from a vehicle black box as its sensed condition, the second sensor node, the first sensor node and the relay node are positioned on a motorized vehicle and the sensed conditions are transmitted by the networked gateway to a central node configured to determine a status of the motorized vehicle.

According to exemplary data communication systems described herein, the at least one sensor node comprises a given sensor node configured to read an identifying code of a remotely-readable identification tag located in proximity of the given sensor node as its sensed condition, and the relay node is located in geographic proximity of the given sensor node, and the identifying code is transmitted by the networked gateway to a central node configured to determine a presence of an object bearing the remotely-readable identification tag at a known location of the given sensor node.

According to exemplary data communication systems described herein, the embedded sensor of the second-layer collector node is a presence detector configured to detect the presence of an object in proximity of the second-layer collector node as its sensed condition, the at least one sensor node comprises a second sensor node configured to read a second identifying code of a second remotely-readable identification tag located in proximity of the second sensor node as its sensed condition, and the detected presence and the second identifying code are transmitted by the networked gateway to a central node configured to determine a presence of the object in proximity of the second-layer collector node and an identification code of the object.

According to exemplary data communication systems described herein, the embedded sensor of the relay node is a magnetometer.

According to exemplary data communication systems described herein, the at least one sensor node comprises a given sensor node configured to detect a position of the given sensor node relative to external reference nodes defining a localized area as its sensed condition, the relay node is located in geographic proximity of the given sensor node, and the position is transmitted by the networked gateway to a central node configured to track a position of an object bearing the given sensor node within the defined localized area.

According to exemplary data communication systems described herein, the at least one sensor node comprises a given sensor node detect an operating mode of a piece of equipment as its sensed condition, the relay node is located in geographic proximity of the given sensor node and the operating mode is transmitted by the networked gateway to a central node configured to track a status of the geographic location of the relay node based on the operating mode of the piece of equipment.

According to exemplary data communication systems described herein, the piece of equipment is a snow removal vehicle and the operating mode is chosen from one or more of traveling, removing snow, salting, spreading road abrasives and the status of the geographic location of the second-layer collector node is chosen from one or more of snow clear, road salted, and abrasives spread.

According to exemplary data communication systems described herein, the piece of equipment is a garbage removal vehicle or recycling vehicle and the operating mode is chosen from removal of garbage or removal of recycled materials and the status of the geographic location of the second-layer collector node is chosen from one or more of garbage removed and recycling removed.

According to exemplary data communication systems described herein, each of the plurality of second-layer nodes is configured to transmit at least one sensed condition within at least one data signal in the wireless low-power long range communication mode and the data signals received at the first-layer node comprises the at least one data signal transmitted from each of the second layer nodes.

According to exemplary data communication systems described herein, the first-layer node is configured to receive the data signals from the plurality of second-layer nodes at a distance greater than 10 km from the second-layer collector nodes and the networked gateway is configured to receive the additional data signal at a distance greater than 10 km from the first-layer node.

According to exemplary data communication systems described herein, at least one of the second-layer nodes receives a sensed condition from a sensor node having a sensor device adapted to sense the condition.

According to exemplary data communication systems described herein, at least one of the second-layer nodes comprises an embedded sensor adapted to sense the condition.

According to exemplary data communication systems described herein, the first-layer node is within line of sight of the networked gateway.

According to exemplary data communication systems described herein, the second-layer node is not within line of sight of the networked gateway.

According to exemplary data communication systems described herein, the first-layer node is located at an elevated position.

According to exemplary data communication systems described herein, the first-layer node is located atop a city building.

According to exemplary data communication systems described herein, the second-layer node is located at ground level.

According to exemplary data communication systems described herein, the first-layer collector node comprises a directional antenna directed at the networked gateway, the additional data signal being transmitted by the directional antenna.

According to exemplary data communication systems described herein, the wireless low-power long range communication mode is a long range internet-of-things protocol.

According to exemplary data communication systems described herein, the first-layer collector nodes comprises a first electronic chip configured to receive and demodulate the wireless low-power long range communication mode the data signals received from the plurality of second-layer collector nodes, a microcontroller configured to aggregate the sensed conditions from the demodulated data signals and a second electronic chip configured to modulate the aggregated sensed conditions to the low-power long range communication mode and transmit the modulated signal as the additional data signal.

According to exemplary data communication systems described herein, the second-layer node comprises an embedded sensor configured to detect the presence of an object in proximity of the second-layer collector node, the detected presence being transmitted as its sensed condition within a data signal in a wireless low-power long range communication mode and the detected presence is transmitted by the networked gateway to a central node configured to determine a presence of the object in proximity of the second-layer collector node.

According to exemplary data communication devices described herein, the wireless short range mode is non-interfering with the wireless low-power long range communication mode.

According to exemplary data communication devices described herein, the low-power long range communication mode is a long range internet-of-things protocol.

According to exemplary data communication devices described herein, the wireless short range mode is chosen from FSK, MSK, GFSK, GMSK or BLE.

According to exemplary data communication devices described herein, wherein the second electronic chip is further configured to adjust a power of the transmitted first data signal.

According to exemplary data communication devices described herein, the devices further comprises a microcontroller configured to transmit a control signal in the first wireless mode to at least one of the sensor nodes.

According to exemplary data communication devices described herein, the device further comprises an embedded sensor configured to sense a condition in proximity of the device and wherein the second electronic chip is further configured to modulate the sensed condition and transmit it within the second data signal.

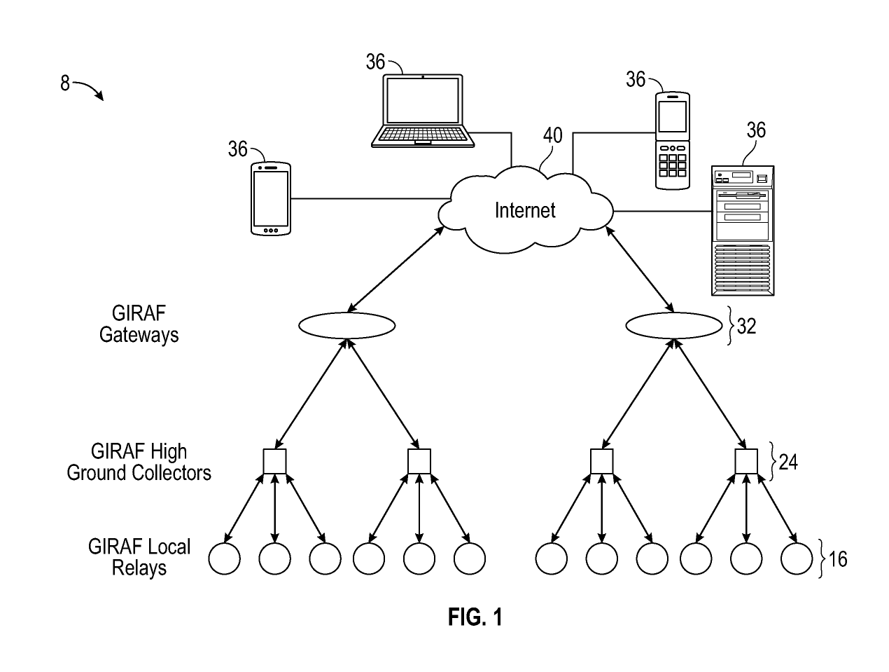

Referring to FIG. 1, therein illustrated is a schematic diagram of an architecture of a first exemplary low-power communication network 8. The first exemplary low-power communication network includes at least three layers of nodes. The nodes of the low-power communication network is arranged in a tree structure and the number of layers refers to the height of the tree other than the root that represents an external wide area network, such as the Internet.

The illustrated low-power communication network 8 includes a second layer of nodes 16, a first layer of nodes 24 and a layer of networked gateways 32, which together form the three layers of nodes. The first layer of nodes 24 are immediate parents to the second layer nodes 16. The networked gateways 32 are immediate parents to the first layer nodes 24. The layer of networked gateways 32 can communicate with one another and/or with external devices 36 via an external wide area network 40, such as the Internet.

A second-layer node 16 is configured to receive data pertaining to a sensed condition. Additionally, or alternatively, the second-layer node 16 may include its own sensing or measuring device to obtain a sensed condition. The second-layer node 16 is further configured to transmit its sensed condition within at least one data signal in the wireless low-power long range communication mode to at least one first-layer node 24.

The at least one data signal transmitted from the second-layer node 16 may be received at a first-layer node 24. Accordingly, the first-layer node 24 is configured to receive the data signal transmitted in the wireless low-power long range communication mode.

The second-layer node 16 may further receive at least one data signal from the first-layer node 24. For example, the received signal may include information for controlling or configuring the second-layer node 16, or a node that is child the second-layer node 16. Accordingly, it will be appreciated that a second-layer node 16 may be in two-way communication with a first-layer node 24.

A first-layer node 24 is configured to receive data signals from a plurality of second-layer nodes 16. That is, the second layer node 24 acts as a collector node for a plurality of second-layer nodes 16. In the illustrated example of FIG. 1, four first-layer nodes 24 each receive data signals transmitted from three second-layer nodes 16.

A first-layer node 24 is further configured to retransmit the sensed conditions contained in the data signals that it receives from the second-layer nodes 16. The sensed conditions are retransmitted within data signals in the wireless low-power long range communication mode.

According to various exemplary embodiments, the first-layer node 24 is configured to aggregate the data pertaining to the received sensed conditions before retransmitting them. That is, the first-layer node 24 does more than merely reroute the data signals. It carries out some processing of the received data signals. For example, various wireless data signals transmitted by the second-layer nodes 16 may have overhead data unrelated to the sensed condition. Accordingly, the first-layer node 24 is configured to remove unnecessary overhead data before retransmitting the aggregated sensed conditions.

The first-layer node 24 may further transmit at least one data signal to the second-layer node 24.

A networked gateway 32 is configured to receive the data signals transmitted in the low-power long range communication mode. In the first low-power network 8, the networked gateway 32 receives data signals transmitted from the one or more first-layer nodes 24. That is, the network gateway 32 acts as a collector node for the plurality of first-layer nodes 24. In the illustrated example of FIG. 1, two network gateways 32 each receive data signals transmitted from two first-layer nodes 24.

The first-layer node 24 may further receive at least one data signal from a networked gateway 32. Accordingly, the networked gateway 32 may be configured to transmit the at least one data signal to the first-layer node 24. The data signal may include information for controlling or configuring the first-layer node 24 or another node that is child to the first-layer node 24. Accordingly, it will be appreciated that a first-layer node 16 may be in two-way communication with a networked gateway 32.

A networked gateway 32 is connected to an external wide-area network, such as the Internet. Accordingly, the networked gateway 32 is configured to transmit the sensed conditions contained in the data signals received from the one or more first-layer nodes. These sensed conditions are transmitted according to the applicable protocol of the external wide-area network 40. For example, this protocol may be the Internet Protocol (IP). These sensed conditions may be transmitted to one or more central workstations that monitor the sensed conditions. The networked gateway 32 may have a two-way connection with the external wide-area network.

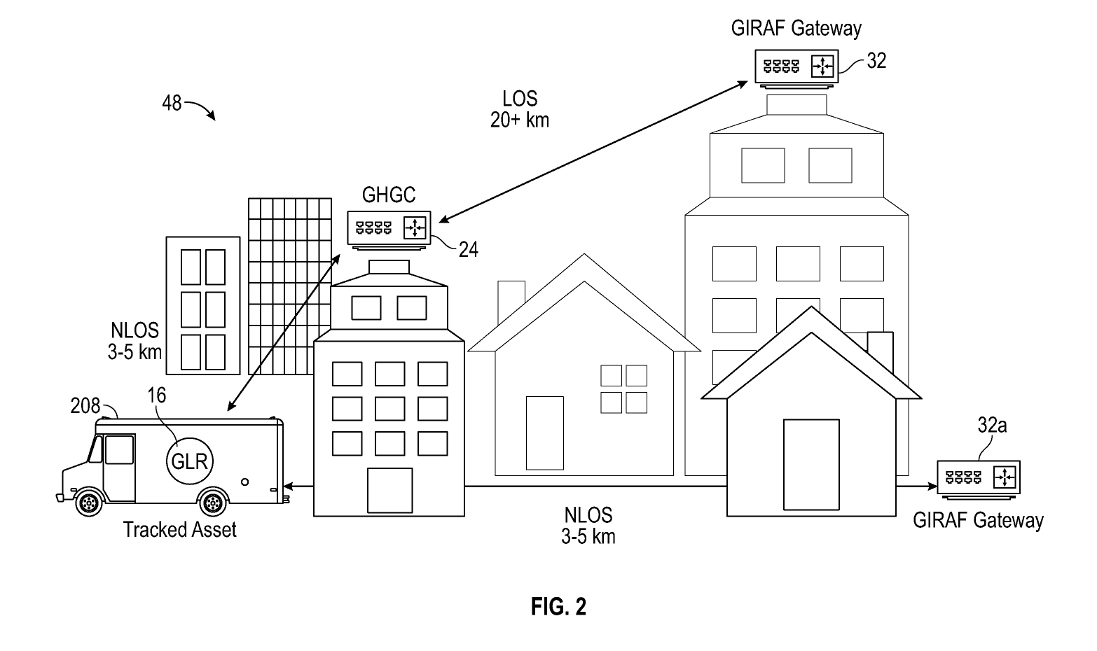

Referring now to FIG. 2, therein illustrated is a schematic diagram of an exemplary deployment 48 of an exemplary low-power communication network 8. It will be understood that the exemplary deployment is illustrated within a city setting but may be applicable to other suitable types of geographical zones.

The exemplary deployment 48 includes one second-layer node 16, one first-layer node 24 and two tracked gateways 32. The second-layer node 16 is positioned on or in vicinity of a tracked object. In the illustrated example, this tracked asset is a vehicle moving about the city and the second-layer node 16 receives at least one sensed condition of the vehicle.

The first-layer node 24 is located within communication range of the second-layer node 16 so that data signals containing the sensed condition transmitted from the second-layer node 16 can be received at the first-layer node 24. The first-layer node 24 further retransmits the sensed condition to the networked gateway 32.

The placement of the one or more first-layer node 24 and the networked gateway 32 are positioned based on their operating communication ranges and based on expected locations of the one or more second-layer nodes 16.

For example the first-layer nodes 24 are positioned so as to be sufficiently close to the expected locations of one or more second-layer nodes 16. This may be within an operating communication range of the second-layer nodes 16. The operating communication range may be an obstructed (i.e. non-line of sight (NLOS)) communication range of the second-layer nodes 16.

For example, and as illustrated a maximum obstructed communication range of the second-layer node may be about 5 km.

In other examples, the second-layer nodes may be tuned to have a lower maximum communication range (including obstructed communication range) in order to lower power consumption.

The networked gateway 32 is located within communication range of the first-layer node 24 so that data signals containing the sensed condition retransmitted from the first-layer node 24 can be received at the networked gateway 32.

The placement of the networked gateway 32 is further based on a communication range of the first-layer node 24.

According to various exemplary embodiments, one or more first-layer nodes 24 and the network gateway 32 are located so that they may be in wireless signal communication free of (i.e. without) any obstructions. That is, the one or more first-layer nodes 24 are within line of sight (LOS) of the networked gateway 32. Accordingly, the networked gateway 32 can be placed at a greater distance away from a first-layer node 24 while still maintaining wireless signal communication.

According to various exemplary embodiments, a first-layer node 24 is located at an elevated position. This allows the first-layer node to be substantially higher than adjacent ground objects. For example, within an urban context, a first-layer node 24 is located atop a building. For example, the first-layer node 24 may be placed at an elevated position of a natural formation, such as a plant, a hill or a mountain. For example, the first-layer node 24 may be placed at an elevated position of an airborne device, such as an aircraft, airborne balloon, or flying drone. Placing the first-layer node 24 on an airborne device may further allow the first-layer node 24 to change its geographical position in a dynamic manner.

The networked gateway 32 may also be located at an elevated position. This also allows the first-layer node to be substantially higher than adjacent ground objects. For example, within an urban context, the networked gateway 32 may also be located atop a city building. For example, the networked gateway 32 may be placed at an elevated position of a natural formation, such as a plant, a hill or a mountain. For example, the networked gateway 32 may be placed at an elevated position of a flying device, such as an aircraft, airborne balloon, or flying drone. Placing the networked gateway 32 on an airborne device may further allow the networked gateway 32 to change its geographical position in a dynamic manner.

According to various exemplary embodiments, the at least one first-layer node 24 and the networked gateway 32 are stationary when deployed. Accordingly, locations of the first-layer node 24 and the networked gateway 32 are known. To take advantage of this, the first-layer node may have a directional transmitting antenna that is directed to the location of a networked gateway 32. Accordingly data signals that contain sensed conditions may be transmitted over an even greater range to the networked gateway.

For example, the first-layer node 24 has a line of sight communications range of at least 10 km.

For example, the first-layer node 24 has a line of sight communications range of at least 20 km.

It will be appreciated that the use of a three-layer low-power communication network 8 provides a greater amount of flexibility during deployment. For example, there is increased freedom in the placement of the network gateway 32 when compared to a two-layer network in which the second-layer node 16 communicates directly with a network gateway 32.

Referring back to FIG. 2, a grounded networked gateway 32a must be placed closer to the second-layer node 16 in order to be within NLOS communication range of the second-layer node 16. By contrast, the elevated network gateway 32 can be located at much greater distance away from the second-layer node 16 while still maintaining signal communication with the second-layer node 16 via the first-layer node 24. Where a large number of second-layer nodes 16 are present, an increased number of network gateways 32 also need to be deployed to be within signal communication range of the second-layer nodes.

By contrast, and for example, the number of network gateways 32 required may be reduced due to the use of one or more first-layer nodes 24. Furthermore, because networked gateways 32 require greater infrastructure investment, the use of one or more first-layer nodes 24 reduces infrastructure investment, which may also decrease deployment lead time.

For example, the use of first-layer nodes 24 also provides greater flexibility in tuning the power requirements of the second-layer nodes 16. Because a second-layer node 16 is often positioned on or near tracked assets, the second-layer node 16 may have significant power limitations. For example, the second layer node 16 may be battery-powered. These power limitations may be met by flexibly placing a first-layer node 24 closer to the second-layer node 16 so that the first-layer node 24 can be tuned to consume less power while still transmitting the sensed condition from the second-layer node 16 to the first-layer node 24.

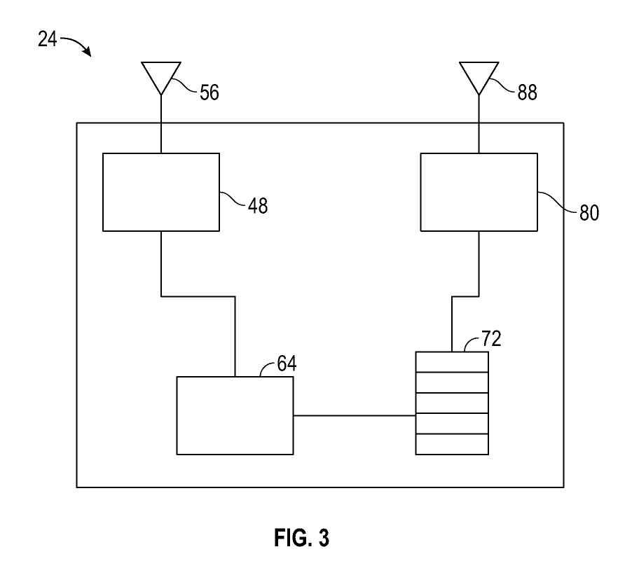

Referring now to FIG. 3, therein illustrated is a schematic diagram of a first layer node 24 according to various exemplary embodiments. The exemplary first layer node 24 includes a first electronic chip 48 configured to at least receive and demodulate wireless signals that are transmitted in a low-power long range communication mode. The first electronic chip 48 may be connected to a antenna 56. The antenna 56 is operable to at least receive wireless signals transmitted in the low-power long range communication mode. Accordingly, the first electronic chip 48 may implemented to have an asynchronous link to receive data signals from a plurality of second-layer nodes 16. For example, the first electronic chip 48 may be configured to demodulate low-power long range signals. For example, the first electronic chip 48 is a SX1301 chip provided by Semtech™.

In some exemplary embodiments, the first electronic chip 48 and the antenna 56 may form a transceiver that is operable to receive and demodulate wireless signals as well as modulate and transmit wireless signals in the low-power long range communication mode. The first electronic chip 48 as a transceiver may operate to transmit a wireless data signal when transmitting a sensed condition to a networked gateway 32. It may also operate to transmit a wireless data signal when transmitting a signal to a child node, such as a second-layer node 16.

Data signals demodulated by the first electronic chip 48 of the first-layer node 24 contain sensed conditions transmitted by a plurality of second-layer nodes 16. Sensed conditions data is received at a controller chip 64. The controller chip 64 described herein may be implemented in hardware or software, or a combination of both. It may be implemented on a programmable processing device, such as a microprocessor or microcontroller, Central Processing Unit (CPU), Digital Signal Processor (DSP), Field Programmable Gate Array (FPGA), general purpose processor, and the like. In some embodiments, the programmable processing device can be coupled to program memory, which stores instructions used to program the programmable processing device to execute the controller. The program memory can include non-transitory storage media, both volatile and non-volatile, including but not limited to, random access memory (RAM), dynamic random access memory (DRAM), static random access memory (SRAM), read-only memory (ROM), programmable read-only memory (PROM), erasable programmable read-only memory (EPROM), electrically erasable programmable read-only memory (EEPROM), flash memory, magnetic media, and optical media.

The controller chip 16 is configured to extract the sensed conditions and aggregates these. The aggregated sensed conditions data may be stored within a buffer 72.

The exemplary first-layer node 24 may further include a second electronic chip 80 configured to receive the aggregated sensed conditions data from the buffer 72 and modulate this aggregated data to the low-power long range communication mode. The second electronic chip 80 is further configured to transmit the aggregated data as a low-power long range communication mode data signal. The second electronic chip 80 and second antenna 88 may be included to implement transmission of data signals via a directional antenna 88. For example, the second electronic chip 48 may be configured to demodulate low-power long range signals. For example, the second electronic chip 80 may be a SX127x family chip from Semtech™.

The first-layer node 24 may be battery-powered. Alternatively, or additionally, the first-layer node 24 may be solar-powered.

The first-layer node 24 may further include a port that allows it to be connected to an external device, such as a PC, laptop, tablet or smartphone. The first-layer node 24 can then be configured or programmed using commands from the PC, laptop, tablet or smartphone.

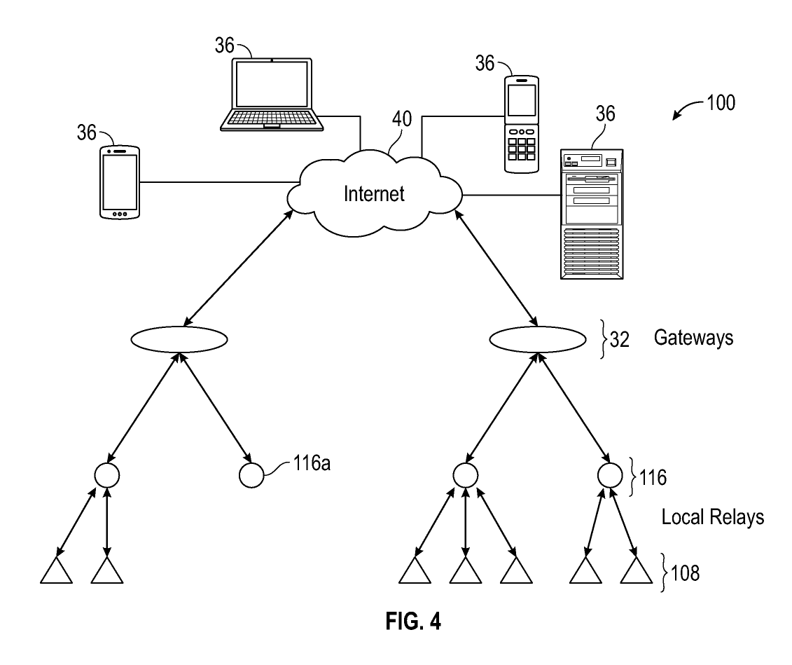

Referring now to FIG. 4, therein illustrated is a schematic diagram of an architecture exemplary low-power communication network 100. The second exemplary low-power communication network includes at least three layers of nodes. The nodes of the second-power communication network is arranged in a tree structure and the number of layers refers to the height of the three other than the root that represents an external wide area network, such as the Internet.

The illustrated second low-power communication network 100 includes a layer of sensor nodes 108, a layer of relay nodes 116 and a layer of networked gateways 32, which together form the three layers of nodes. The relay nodes 116 are immediate parents to the sensor nodes 108. The networked gateways 32 are immediate parents to the relay nodes. The layer of networked gateways 32 can communicate one another and/or with external devices 36 via an external wide area network 40, such as the Internet.

A sensor node 108 is configured to sense at least one condition. The sensor node 108 may include a sensing device operable to sense the condition. Alternatively, the sensor node 108 is in signal communication with a sensing device that is operable to sense the condition.

The sensor node 108 is further configured to transmit its sensed condition within at least one data signal in a wireless short range mode. According to various exemplary embodiments, the wireless short range mode used by the sensor node 108 is a wireless mode that is non-interfering with the wireless low-power long range communication mode used elsewhere within the second power low-power communication network 100. For example, the sensor node 108 can include a SX1243 chip from Semtech™.

A relay node 116 is configured to receive data signals from one or more sensor nodes 116 transmitted in the wireless short range mode. That is, the relay node 116 acts a collector node for a plurality of sensor nodes 108. The relay node 116 may be configured to aggregate data pertaining to the received sensed conditions before retransmitting them. That is, the relay node 116 does more than merely reroute the data signals. It carries out some processing of the received data signals. For example, various wireless data signals transmitted by the sensor nodes 108 may have overhead data unrelated to the sensed condition. Accordingly, the relay node 116 is configured to remove unnecessary overhead data before retransmitting the aggregated sensed conditions.

In the illustrated example of FIG. 4, three relay nodes 116 receive data signals transmitted from two sensor nodes 108, three sensor nodes 108 and two sensor nodes 108, respectively.

According to various exemplary embodiments the relay node 116 may include its own sensing or measuring device to obtain sensed condition. In the illustrated example, fourth relay node 116a has its own sensing device and therefore receives sensed conditions without receiving a sensed condition from a sensor node 108.

The relay node 116 is further configured to transmit the sensed conditions that it receives within at least one data signal in the wireless low-power long range communication mode to a parent node.

According to various exemplary embodiments, the relay node 116 may transmit signals to one or more sensor nodes 108 that include information for controlling or configuring the sensor nodes 108. That is, the relay node 116 may be in two-way communication with one or more sensor nodes 108.

It will be understood that according to various exemplary embodiments, the relay node 116 and the second layer node 16 may be used interchangeably. Both the relay node 116 and the second-layer node 16 are configured to receive a sensed condition and/or sense a condition using its own sensing device. Furthermore, both the relay node 116 and the second-layer node are configured to transmit the at least one sensed condition within at least one data signal in the wireless low-power long range communication mode to a parent node. It will be understood that second layer node 16 described herein may also refer to a relay node 116.

Continuing with FIG. 4, a network gateway 32 is configured to receive data signals transmitted in the low-power long range communication mode. In the second low-power communications network 100, the networked gateway 32 directly receives data signals transmitted from the one or more relay nodes 116. Accordingly, like in the first low-power communications network 8, the network gateway 32 acts a collector node and transmits the sensed conditions according to the applicable protocol of the external wide-area network. For example, this protocol may be the Internet Protocol (IP). These sensed conditions may be transmitted to one or more central workstations that monitor the sensed conditions.

According to various exemplary embodiments, the relay node 116 may receive signals from a networked gateway 32 that includes information for controlling or configuring the relay node 116. That is, the relay node 116 may be in two-way communication with the networked gateway.

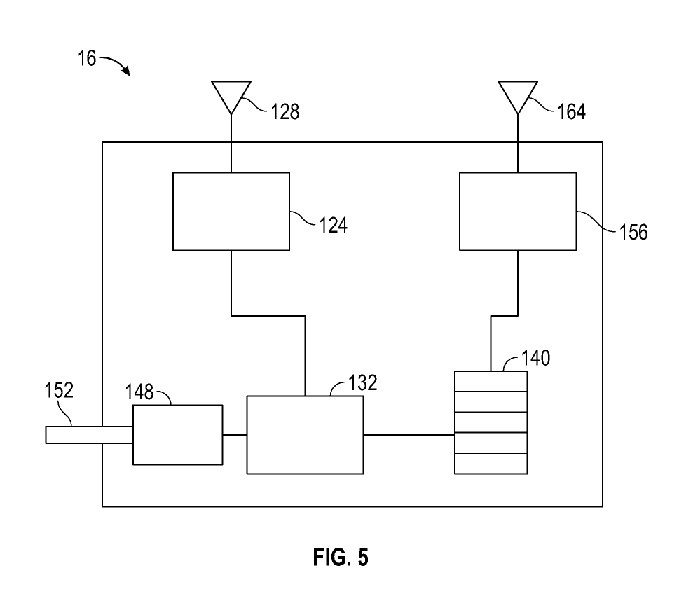

Referring now to FIG. 5, therein illustrated is a schematic diagram of a second-layer node 16 (or relay node 116) according to various exemplary embodiments. The exemplary second-layer node includes a first electronic chip 124 configured to receive and demodulate wireless signals that are transmitted in the wireless short range mode. This wireless short range mode is the mode in which the sensor nodes 108 transmit data signals containing sensed conditions. The first electronic chip 124 may be connected to an antenna 128. Accordingly, the first electronic chip 124 may be implemented to have an asynchronous link to receive data signals from a plurality of sensor nodes 108. For example, the first electronic chip 124 of the second-layer node 16 is a SX1243 chip from Semtech™. For example, the first electronic chip 124 and antenna 128 may be implemented as a transceiver that is operable to receive and demodulate wireless signals as well as module and transmit wireless signals in the wireless short range communication mode.

Data signals demodulated by the first electronic chip 124 of the second-layer node 16 contain sensed conditions transmitted by a plurality of sensor nodes 108. Sensed conditions data is received at a controller chip 132. The controller chip 132 described herein may be implemented in hardware or software, or a combination of both. It may be implemented on a programmable processing device, such as a microprocessor or microcontroller, Central Processing Unit (CPU), Digital Signal Processor (DSP), Field Programmable Gate Array (FPGA), general purpose processor, and the like. In some embodiments, the programmable processing device can be coupled to program memory, which stores instructions used to program the programmable processing device to execute the controller. The program memory can include non-transitory storage media, both volatile and non-volatile, including but not limited to, random access memory (RAM), dynamic random access memory (DRAM), static random access memory (SRAM), read-only memory (ROM), programmable read-only memory (PROM), erasable programmable read-only memory (EPROM), electrically erasable programmable read-only memory (EEPROM), flash memory, magnetic media, and optical media.

The controller chip 132 is configured to extract the sensed conditions and aggregates these. The aggregated sensed conditions data may be stored within a buffer 140.

According to various exemplary embodiments, the second-layer node 16 may further include a sensor chip 148 operable to a condition of the second-layer node 16 or a condition in vicinity of the second-layer node 16. For example, the sensor chip 148 may be connected to a probe member 152 for sensing the condition.

The exemplary second-layer node 16 further includes a second electronic chip 156 configured to receive the aggregated sensed conditions data from the buffer 140 and modulate this aggregate data to the low-power long range communication mode. The second electronic chip 156 is further configured to transmit the aggregated data as a low-power long range communication mode data signal. For example, the data signal is transmitted via an antenna 164. For example, the second electronic chip 156 may be a SX127x family chip from Semtech™. For example, the second electronic chip 156 and antenna 164 may be implemented as a transceiver that is operable to receive and demodulate wireless signals as well as module and transmit wireless signals in the low-power long range communication mode.

The second-layer node 16 may be battery-powered. Alternatively, or additionally, the first-layer node may be solar-powered.

The second-layer node 16 may further include one or more ports that it allows to be connected to an external device, such as a PC, laptop, tablet or smartphone. The first-layer node 16 can then be configured or programmed using commands from the PC, laptop, tablet or smartphone.

According to various exemplary embodiments, the second-layer node 16 is configured to receive a signal to receive a command sent remotely to modify its power output. In other examples, the second-layer node 16 may be configured to automatically adjust its power output.

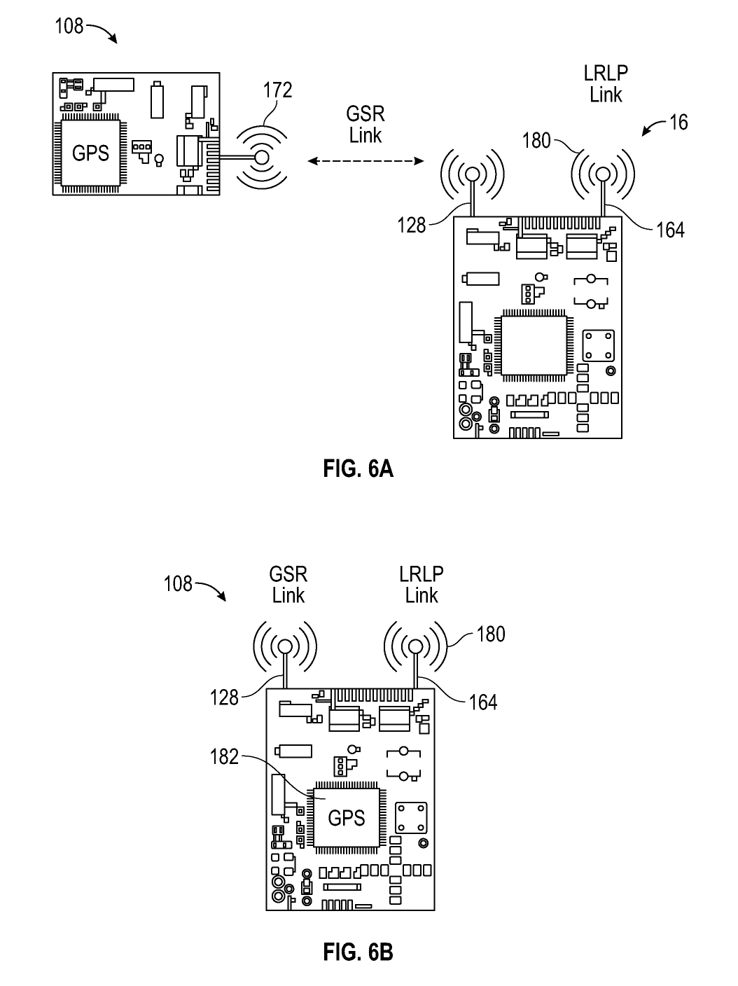

Referring now to FIG. 6A, therein illustrated is a schematic diagram of an interaction between an exemplary sensor node 108 and an exemplary relay node 16. A first data signal 172 is transmitted from the sensor node 108 in the wireless short-range mode. For example, the data signal 172 has a power less than 10 dBm. The relay node 16 then retransmits the sensed condition contained in the first data signal 172 as a second data signal 180 in the low-power long range communication mode. By choosing a wireless short-range mode that is non-interfering with the low-power long range communication mode, but the first data signal 172 and the second data signal 180 may be active without colliding or interfering with one another.

Referring now to FIG. 6B, therein illustrated is a schematic diagram of an exemplary relay node 16 having an embedded sensor 182.

In an exemplary deployment, one or more sensor nodes 108 are positioned in vicinity and within signal communication range of a relay node 116. For example, the one or more sensor nodes 108 and the relay node 116 are placed within or on a tracked asset. Conditions sensed by the sensor nodes 108 are transmitted to the relay node 116. The relay node 116 then retransmits the sensed conditions to a first-layer node 24 or to a networked gateway 32.

It will be appreciated that by combining one or more sensor nodes 108 with a relay node 116, only one of these nodes (the relay node 116) needs to be configured to be operable to communicate in the low-power long range communication mode over a larger distance. The remaining nodes (the one or more sensor nodes) need to only to communicate over a short range with relay node 116. Accordingly, the sensor nodes 108 can have reduced power consumption and/or complexity, for example, when compared to an implementation wherein each sensor node 108 communicates directly with a first-layer node 24 or networked gateway 32 that is located remotely of the sensor nodes 108.

It will also be appreciated that by using sensor nodes 108 that are operable to communicate wireless with the relay node 116, a monitoring operation of a tracked asset may be easily implemented and upgraded. For example, at least one sensor node 108 can be easily located at a desired location within a tracked asset an establish signal communication with the relay node 116 without having to run physically wires throughout the tracked asset. Furthermore additional one or more sensor nodes 108 may be added or removed as required without having to run further wires. This may be particular useful for retrofitting certain tracked assets (ex: vehicles) in situations where running wires may be particularly difficult. Furthermore, by having the sensor node 108 communicate with the relay node 116 in a first wireless network mode that is non-interfering with the low-power long range communication mode, both the sensor node 108 and the relay node 116 may be active at the same time, thereby increasing efficiency.

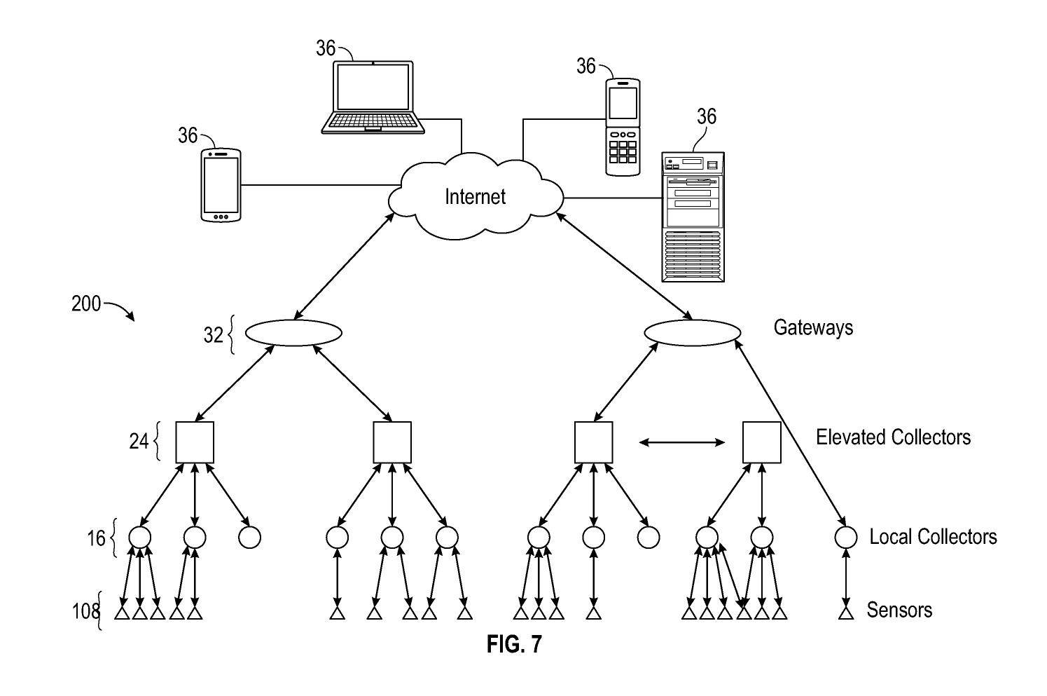

Referring now to FIG. 7, therein illustrated is a schematic diagram of a third exemplary low-power communication network 200. The third low-power communication network includes at least four layers of nodes. The nodes of the third low-power communication network is arranged in a tree structure and the number of layers refers to height of the tree other than the root that represents an external wide area network, such as the Internet.

The third low-power communication network 200 has from parent to child a layer of networked gateways 32, a first layer of nodes 24, a second layer of nodes 16 and a layer of sensor nodes 108. It will be appreciated that the third low-power communication network 200 is a combination of the first low-power communication network 8 and the second low-power communication network 100. With respect to first low-power communication network 8, the third low-power communication network 200 differs in that a layer of sensor nodes 108 are introduced. With respect to second low-power communication network 100, the third low-power communication network 200 differs in that the second-layer nodes 16 (relay nodes 116) communicate with the first-layer nodes 24 instead of directly with the networked gateways 32.

In operation, sensor nodes 108 sense conditions, which are transmitted within first wireless data signals in the wireless short range mode to the second-layer nodes 16. The sensed conditions may also be aggregated at the second-layer nodes 16. The sensed conditions may be further transmitted within second data signals in the low-power long range communication mode from the second-layer nodes 16 to the first-layer nodes 24. The sensed conditions may be further aggregated at the first layer nodes 24. The sensed conditions may be further transmitted within third data signals in the low-power long range communication mode from the first-layer nodes 16 to the networked gateways 32. These sensed conditions are then transmitted over an external wide area network 40, such as over the Internet according to Internet Protocol.

According to various exemplary embodiments, a first-layer node 24 may be in communication with another first-layer node 24. Accordingly, a given first-layer node 24 may transmit sensed conditions to another first-layer node 24, which then transmits the sensed conditions to a network gateway 32. For example, and as illustrated, one of the first-layer nodes 24 has a communication link with another first-layer node 24. This first-layer node may not be in communication with a networked gateway 32. This configuration may be implemented where networked gateways 32 are spread out over a large area and sensed conditions are relayed amongst first-layer nodes 24 before reaching a networked gateway 32.

According to various exemplary embodiments, a second-layer node 16 may be in direct communication with a networked gateway 32. Accordingly, a data signal transmitted by that second-layer node 16 is received by the networked gateway 32 without having passed via a first-layer node 24. For example, and as illustrated, one of the second-layer nodes 16 receives sensed conditions from one sensor node 108 and retransmits those sensed conditions directly to a networked gateway 32. It will be appreciated that this configuration is similar to the one found in the second low-power communication network illustrated in FIG. 4. This configuration may be implemented where a given second-layer node 16 is located sufficiently close to networked gateway 32 such that it is more advantageous to communicate directly with that networked gateway 32 than to communicate via a first-layer node 24.

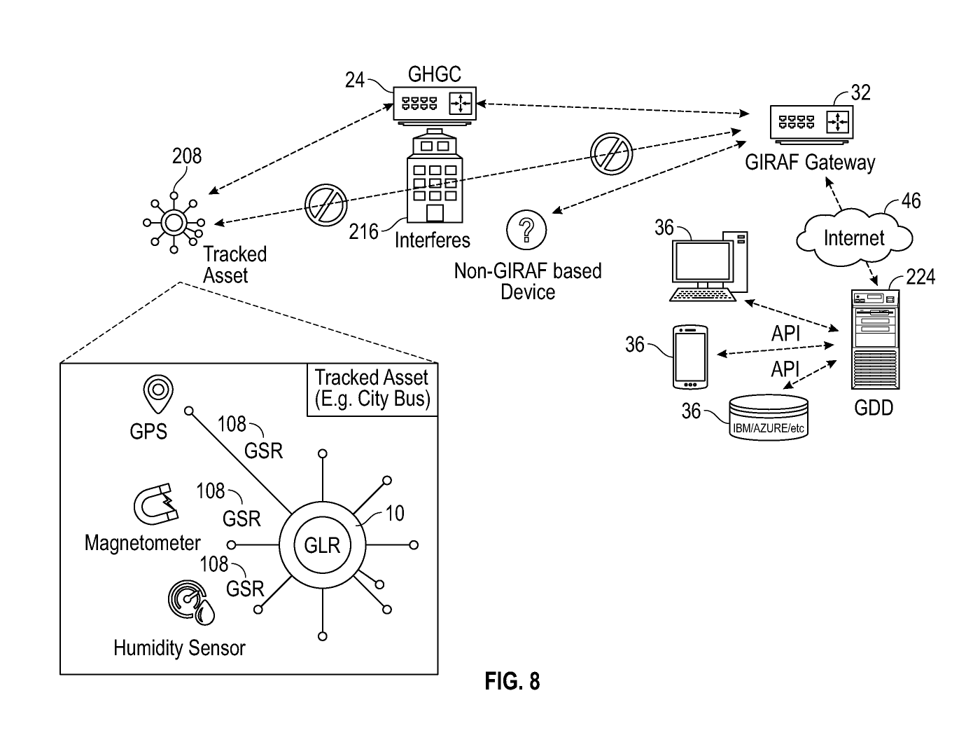

Referring now to FIG. 8, therein illustrated is a schematic diagram of an exemplary deployment of third low-power communication network 200. In the illustrated example, a tracked asset 208 contains sensor nodes 108 and second-layer node 16. For example, the tracked asset 208 is a city bus. The sensor nodes 108 include a global positioning system (GPS), magnetometer and humidity sensor, which respectively sense a location of the city bus, an open/closed state of the bus door and a humidity level within the bus.

According to various exemplary embodiments, a proprietary protocol suite may be implemented to serve one or more layers above the wireless short range mode and/or wireless low-power long range mode. For example, the protocol suite may handle addressing, routing, and packet forwarding between one or more of the sensor nodes 108, second-layer nodes 16, first-layer nodes 24 and networked gateways 32.

In some of the illustrated examples, a proprietary suite called Generic IoT-RF-Application Framework (GIRAF) is implemented to provide communication between nodes over the wireless short-range mode and/or the wireless low-power long range mode. Accordingly, sensor nodes 108 are denoted as GIRAF Short Range nodes (GSR), second-layer nodes 16 are denoted as GIRAF Local Relay (GLR) and first-layer nodes 24 are denoted as GIRAF High Ground Collector (GHGC). One or more central workstations that receive the monitored sensed conditions are denoted as GIRAF Data Dispatcher (GDD).

However, it will be understood that other suitable proprietary or non-proprietary protocols, such as LoRaWan and LoRaLAN, may be implemented to provide communication between nodes.

The protocol suite may further provide encryption of data signals transmitted wirelessly. It will be appreciated that encryption will be important in various internet-of-things applications where privacy might be an issue.

Referring back to FIG. 8, the tracked asset 208 may be located somewhere where the second-layer node 16 is not within signal communication range of its nearest networked gateway 32. This may be due to interference caused by an obstruction 216. However, the second-layer node 16 is in signal communication with a nearby first-layer node 24. For example, the first-layer node 24 is located at an elevated position.

The first-layer node 24 is further in signal communication range with the networked gateway 32. For example, the first-layer node 24 is within line of sight of the networked gateway 32.

Accordingly, conditions sensed by the sensor nodes 108 are transmitted via the second-layer node 16, the first-layer node 24 and the networked gateway 32 to the wide-area network 40. The sensed conditions may be collected at central node 224. The central node 224 may be a workstation, server, or human-operated monitoring service that monitors and/or determines a status of the tracked asset based on the received sensed conditions.

The status of the tracked asset may be shared with devices 36. In the example of a city bus, the status may include a current location of the city bus, whether the city bus is loading and unloading bus, a number of passengers on the bus, and the ambient temperature and/or humidity within the bus.

The status may be also monitored to determine whether the tracked asset 208 should be modified in any way. According to various exemplary embodiments, commands may also be issued from the central node to the tracked asset 208. These commands may be transmitted over the two-way communication capabilities of one or more of the networked gateway 32, first-layer nodes 24, second-layer nodes 16 and sensor node 108. These commands may be relayed over the low-power network or over a separate network, such as cellular telecommunication work (ex: 3G, 4G, LTE, EDGE network).

It will be appreciated that the deployment illustrated in FIG. 2 may also be applicable to the third low-power communication network 200. The tracked asset 208 may contain one or more sensor nodes 108 (not illustrated) that communicate with the second-layer node 16.

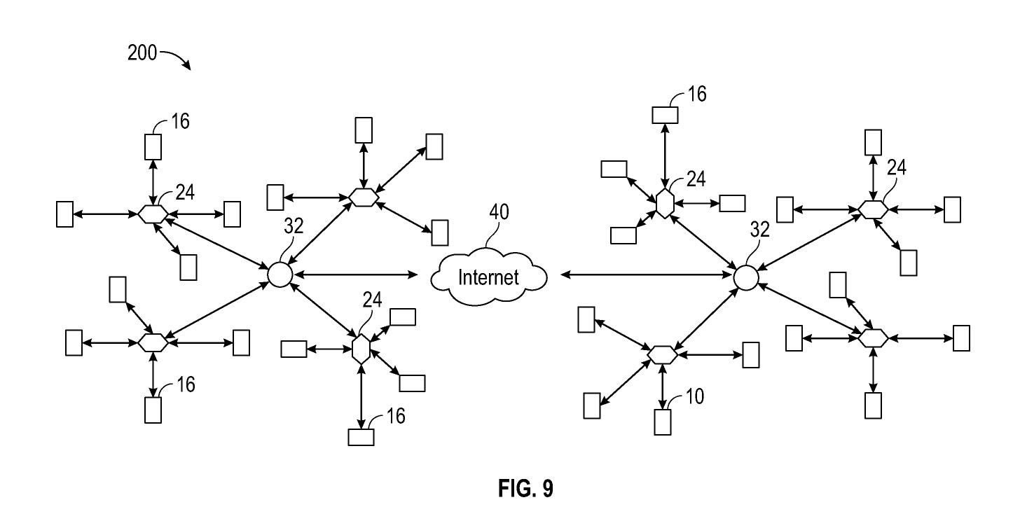

Referring now to FIG. 9, therein illustrated is a schematic diagram of an exemplary distribution of nodes within a low-power communication network 200. A large number of second-layer network nodes 16 may be distributed over a large geographical area to receive sensed conditions. These sensed conditions may be received for sensor nodes 108 (not shown) that are placed on tracked assets. Tracked assets may be mobile. Accordingly, sensor nodes 108 and second-layer network nodes 16 may also be mobile.

A lesser number of first-layer network nodes 24 are distributed over the geographical area to receive sensed conditions data from the second-layer nodes 16. Where second-layer network nodes 16 are mobile, it may communicate with different first-layer network nodes 24 depending on its location within the geographical area.

A yet lesser number of network gateways 32 are distributed over the geographical area to received sensed conditions data from the first-layer nodes 24.

It will be understood that and as described elsewhere herein, according to various exemplary embodiments, a first-layer node 24 does not necessary have transmit sensed conditions directly to a networked gateway 32. Some of the first-layer nodes 24 may transmit sensed conditions to another first-layer node 24 so this other node 24 transmits the sensed conditions to a networked gateway 32.

First layer nodes 24 and network gateways 32 may be strategically distributed based on a topography of the geographic area. The distribution may be based on one or more expected locations of second-layer nodes 16, interference between nodes and third party devices, desired signal intensity of data signals, expected number of devices within a defined geographic area, and a maximum number of second-layer nodes 16 that can be simultaneously served by a first-layer node 24.

For example, the low-power communication network 200 may be deployed to cover a city mesh, a road spread, or inland waterways.

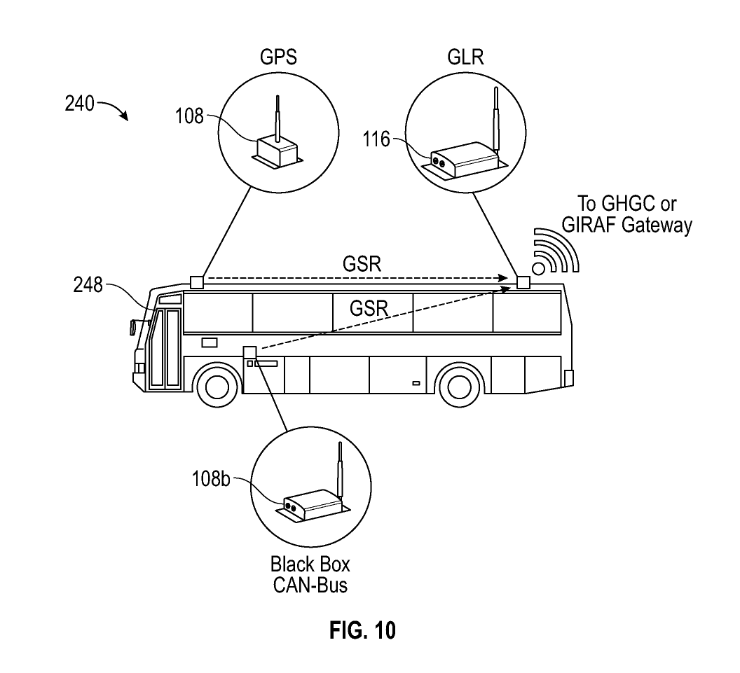

Referring now to FIG. 10, therein illustrated is a schematic diagram of a first exemplary operation 240 of a low-power communication network according to various exemplary embodiments described herein. Within the first operation 240, a moving vehicle 248 has positioned thereon at least one sensor node. In the illustrated example, a first sensor node 108a operable to detect a location (ex: GPS) of the node is positioned on the vehicle 248. A second sensor node 108b is operable to receive black box data from a black box of the vehicle. For example, the second sensor node 108b may have a black box port, such as a CAN-Bus port, for interfacing with the black box of the moving vehicle. The black box measures various conditions of the moving vehicle.

Conditions sensed by the first sensor node 108a and second sensor node 108b are communicated to a relay node 116, which may be a second-layer node 16. The relay node 116 further retransmits the sensed conditions to a remotely located node, which may be a networked gateway 32 or first-layer node 24. The sensed conditions are further transmitted to a central node 224 that is configured to determine a status of the motorized vehicle.

The first exemplary operation 240 allows monitoring conditions of the moving vehicle 248.

It will be appreciated that additional sensor node(s) 108 may be easily added to the operation to sense other conditions of the moving vehicle 248 by having such additional sensor node(s) 108 establish signal communication with the relay node 116.

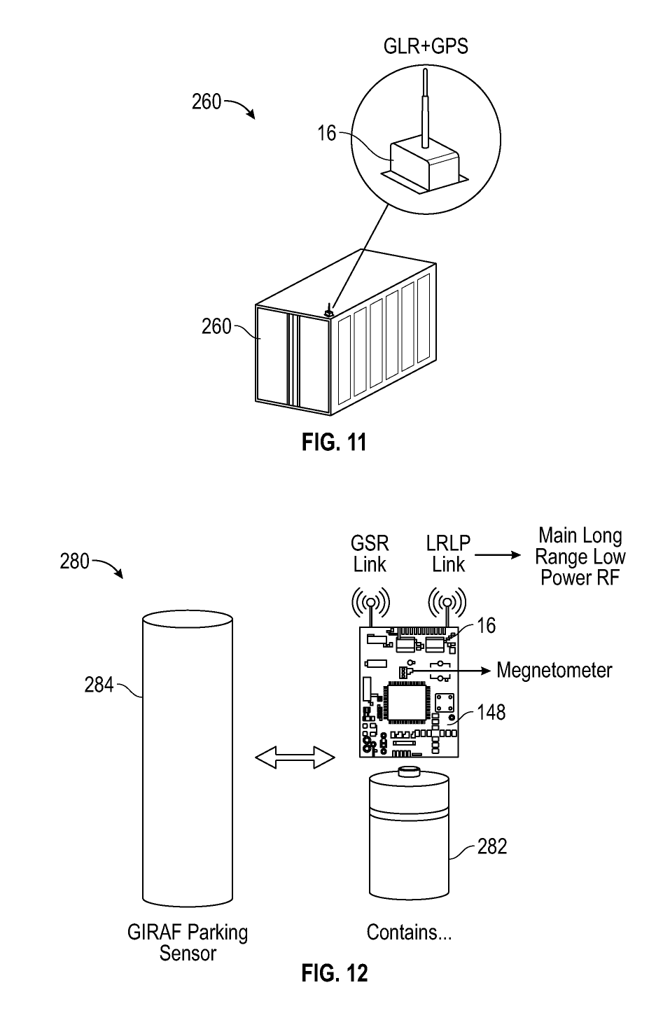

Referring now to FIG. 11, therein illustrated is a schematic diagram of a second exemplary operation 260 of a low-power communication network according to various exemplary embodiments described herein. Within the second operation 260, a node operable to determine its own location is placed on an object 268 whose current location is to be tracked. As illustrated, the tracked object 268 is a shipping container.

The node placed on the tracked object 268 may be a sensor node 108 (not shown) having a locating sensor (ex: GPS). In such a case, the sensor node 108 transmits its current location as a sensed condition to a relay node 116 (second-layer node 16), which retransmits the current location to a remotely located node, which may be a networked gateway 32 or first-layer node 24. The current location is further transmitted to a central node 224 that is configured to track a location of the tracked object. The relay node 116 is either also placed on the tracked object 260 or placed in vicinity of the tracked object 260.

Alternatively, and as illustrated the node placed on the tracked object 268 may be a second-layer node 16 having an embedded locating sensor operable to determine a location of the second-layer node 16. The location determined by the embedded sensor is transmitted by the second-layer node 16 to remotely located node, which may be a networked gateway 32 or first-layer node 24.

According to various exemplary embodiments, the locating sensor found in either the sensor node 108 or embedded within the second-layer node 16 determines its location relative to external reference devices defining a localized area. That is, the locating sensor detects its position within the localized area. For example, the locating sensor and external reference devices are Decawave™ emitters and Decawave™ anchors. This operation may be useful where multiple tracked objects are constantly moved within the localized area, such as containers in a warehouse.

Referring now to FIG. 12, therein illustrated is a schematic diagram of a presence detector device 280 according to various exemplary embodiments. The operation 280 is carried out to detect and track the presence of an object within a localized area. The presence detector device 280 a second layer-node 16 has an embedded presence detector 148. For example, and as illustrated, the presence detector 148 is a magnetometer that is operable to detect a metallic or ferromagnetic object within its proximity. The second layer-node 16 and a power source 282 (ex: battery) are housed within an enclosure 284.

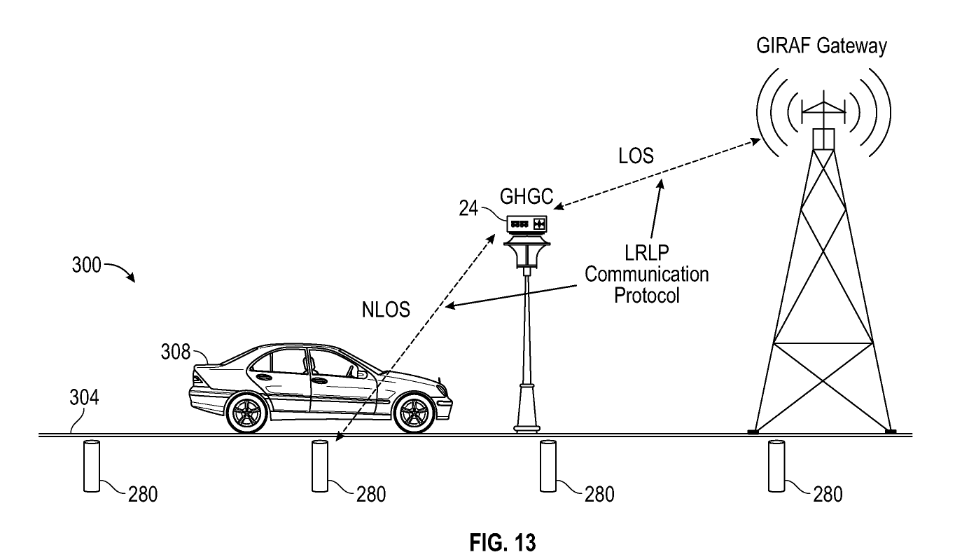

Referring now to FIG. 13, therein illustrated is a schematic diagram of a third exemplary operation 300 of a low-power communication network according to various exemplary embodiments described herein. A plurality of presence detector devices 280 each housing its own second-layer node 16 and power source For example, and illustrated, the presence detector devices 280 are installed below the ground surface 304. Each position of an enclosure may correspond to a parking spot. When a vehicle 308 is parked above one of the presence detector devices 280, the presence detector 148 housed within that enclosure detects the presence of the vehicle 308. The detected presence is transmitted as a sensed condition by the second-layer node 16 to a remotely located node 24.

The ground surface 304 (ex: pavement, asphalt) covering the enclosure 24 may attenuate the data signal transmitted in the low-power long range communication mode from the second-layer node 16 housed in the enclosure 284. Furthermore, the presence of the vehicle 308 above the enclosure may further attenuate the data signal transmitted from the second-layer node 16. Accordingly, in operation, a first-layer node 24 is positioned sufficiently close to the presence detector 280 so as to maintain signal communication with the presence detector 280 despite attenuation of the signal. For example, and as illustrated, the first-layer node 24 is positioned atop an elevated structure, such as a lamppost.

Detected presences of vehicles are transmitted to a central node 224, which can then monitor presence of vehicles. For example, the central node 224 can monitor how many parking spots are occupied and how many are unoccupied. The central node 224 can further monitor which parking spots are occupied and which parking spots are unoccupied. This may be useful for users to quickly find unoccupied parking spots.

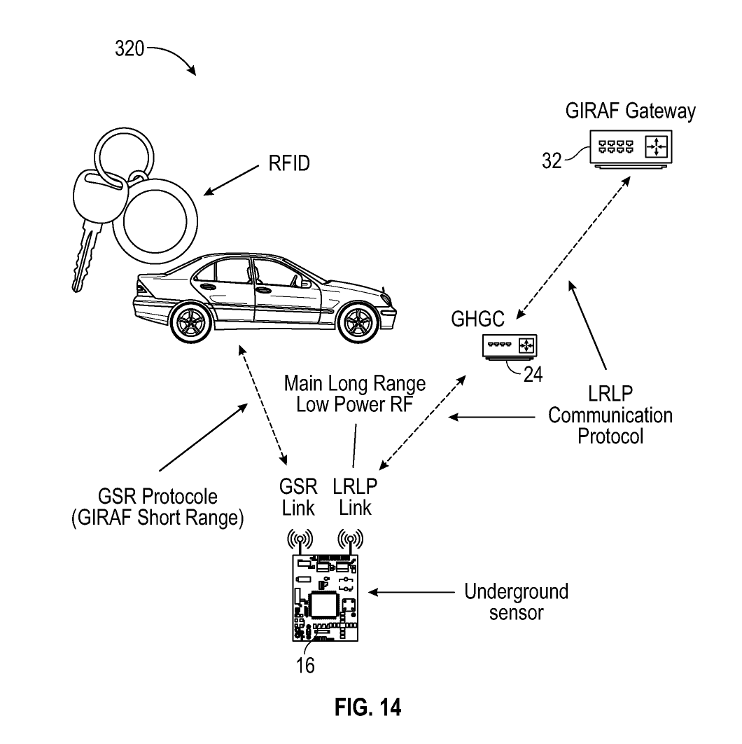

Referring now to FIG. 14, therein illustrated is a schematic diagram of the third operation that has been expanded. Within this exemplary operation, objects are each equipped with a remotely-readable identification tag that uniquely identifies each objects. For example, the remotely-readable identification tag may be positioned on the object (ex: vehicle), or an object associated to the object (ex: keys of the vehicle).

The expanded operation 320 includes a node that is configured to receive an identifying code of a remotely-readable identification tag. For example, the second-layer node 16 may include an embedded identifying code reader, such as an RFID reader, that is configured to read a remotely-readable identification tag position in proximity of the second-layer node 16.

Alternatively, the remotely-readable identification tag acts a sensor node 108 and transmits a data signal that includes its unique identification code to the second-layer node 16.

It will be appreciated that when the reading of the unique identification code of a tag of an object is read in combination with detecting the presence of that object, it may be possible to identify which object is present and monitoring the presence of that object at a known location. For example, the expanded third operation may be a smart parking application, wherein a vehicle is identified by reading the unique identification code of the vehicle, and the amount of time parked is tracked (from tracking the presence of the vehicle). The owner of the vehicle may then be charged based on the amount of time parked and the location of the vehicle.

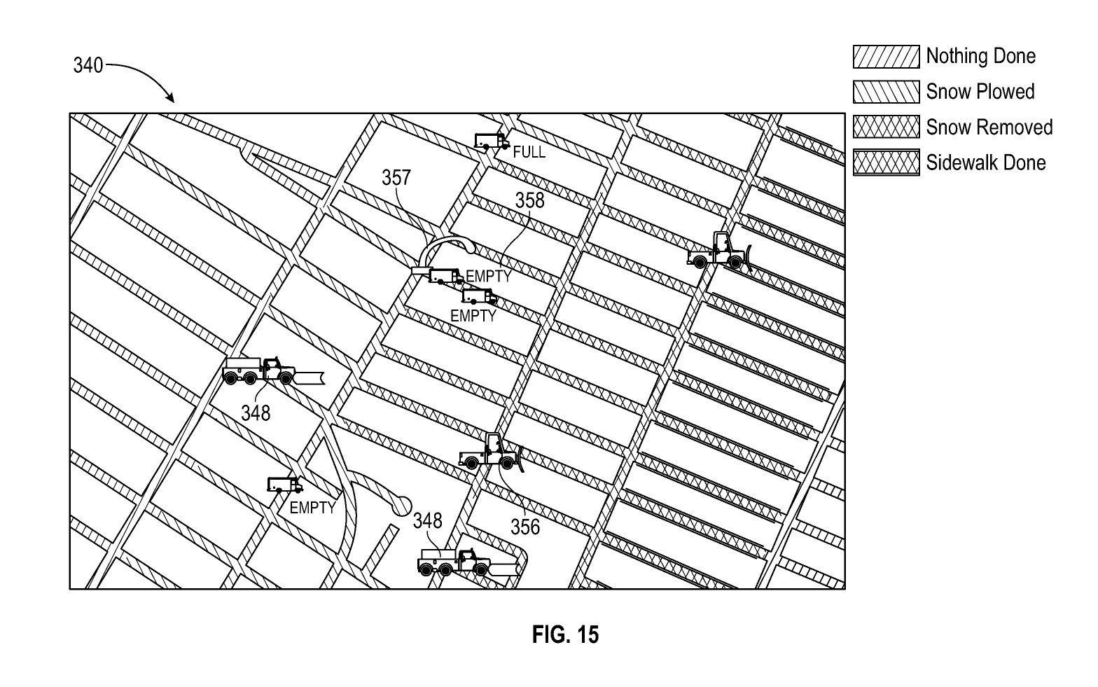

Referring now to FIG. 15, therein illustrated is a schematic diagram of a fourth exemplary operation 340 of a low-power communication network according to various exemplary embodiments described herein. At least one tracked asset that is a piece of equipment is distributed over a given geographic area, such as a city. Each piece of equipment includes at least a first sensor node 108 that detects an operating mode of the piece of equipment as a sensed condition and a second sensor node 108 that determines a location of the piece of equipment (ex: GPS). Each piece of equipment further includes a relay node 116 (or second-layer node 16) that receives the operating mode and the location and retransmits these sensed conditions in the low-power long range communication mode to a remotely located node, which may be a first-layer node 24 or a networked gateway 32.

A central node 224 that receives the geographical location and the operating mode of the piece of equipment can then monitor a status of that geographic location based on how the piece of equipment is being operated.

According to one exemplary embodiment, and as illustrated in FIG. 15, the operation 340 is a snow removal operation. Accordingly, each piece of equipment is a snow removal vehicle. The operating modes of the snow removal vehicle. Different types of snow removal vehicle may have different operating modes. For example, a snow plow 348 has the operating modes of traveling (while not plowing) and snow plowing. By tracking that the snow plow 348 is operating to plow snow over a given geographic area (ex: a given street), it can be determined that the snow in that area (ex the given street) has been plowed. Other operating modes of the snow plow 348 may include snow plowing and salting, snow plowing and spreading road abrasives

For example, a snow removal vehicle that is a sidewalk plow 356 may have the operating modes of traveling (while not plowing) and sidewalk plowing. Accordingly, it is possible to track if the sidewalks of streets have been cleared of snow.

For example, a snow removal vehicle that is a snow collector 357 may have the operating modes of travelling (while not collecting) and snow collecting. Accordingly, it is possible to track if the snow of a street has both been plowed and removed (i.e. collected).

For example, a snow removal vehicle that is snow carrying truck 358 may have as its sensed condition the amount that it has been filled up with snow. Accordingly, by tracking locations and filled-up amount of snow carrying trucks 358, it may be possible to more efficiently dispatch trucks 358 to snow collectors 357 that are collecting snow.

According to another exemplary embodiment, the operation 340 is a garbage collection operation. Accordingly, each piece of equipment is a garbage removal vehicle or recycling vehicle. The operating modes may be traveling (not collecting), removal of garbage and/or removal of recycled materials. By tracking that a garbage removal vehicle is operating to collect garbage and/or recycled material over a given geographic area (ex: a given street), it can be determined that the garbage and/or recycled material over the given area (ex: street) has been removed. In some exemplary embodiments, it may be possible to track which buildings (addresses) have had their garbage and/or recycled material removed.

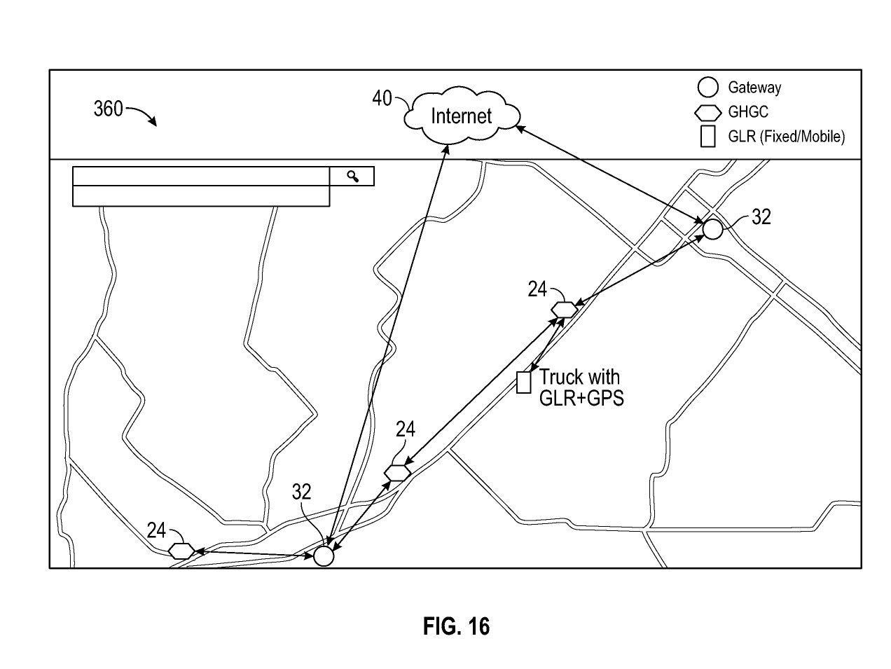

Referring now to FIG. 16, therein illustrated is an exemplary distribution 360 of nodes of a low-power communication network over a geographic area. First-layer nodes 24 and networked gateway 32 are dispersed over a wide geographic area. For example, networked gateways 32 are placed in populated area where infrastructure for connecting to an external wide area network 40 is readily available. In the illustrated example, the networked gateways 32 are located near the cities of Drummondville and Saint-Hyacinthe. For example, first-layer nodes 24 are located in less populated areas and cover corridors where tracked assets having second-layer nodes 16 will likely be passing. For example, the first-layer node 24 are located along a transport corridor, such as a road or highway. It will be appreciated that the exemplary distribution 360 represents an example where first-layer nodes 24 may be in communication with one another. For example, one of the first-layer node 24 located along a transportation corridor will communicate its sensed condition to another first-layer node 24 located along the corridor. The other first-layer node 24 will then transmit the sensed condition to a networked gateway 32.

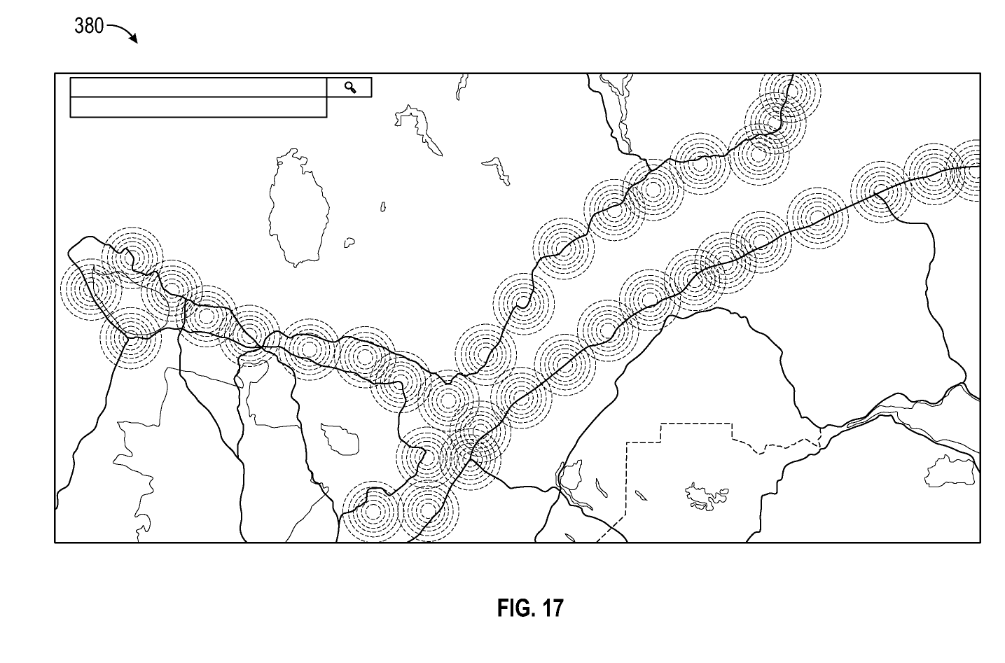

Referring now to FIG. 17, therein illustrated is another exemplary distribution 380 of a low-power communication network. In the illustrated example, first-layer nodes 24 are located along the coast lines of major waterways to track ships and their cargo. The ships and/or their cargo are equipped with second-layer nodes 16 and sensor nodes 108 that sense conditions of the ships and/or cargo and transmit these to the first-layer nodes 16.

It will be understood that the examples provided herein do not represent an exhaustive listing of possible application of various data communication devices, systems, configurations, deployments, networks, and architectures described herein. For example various data communication devices, systems, configurations, deployments, networks, and architectures described herein may be applied in medical and biomedical fields, in the field of personal health and fitness tracking, and in the field of intelligent homes. In other examples, they may be deployed in a temporary or ad hoc manner, such as for events (ex: party, concert, sporting event, etc) and operations (ex: rescue operation, remote area operations, such as mining, forestry, off shore operations, and infrastructure setup).

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

1. A data communication system comprising:
at least one sensor node configured to sense a condition and transmit the sensed condition within a first data signal in a wireless short-range mode;
a relay node configured to receive the first data signal transmitted from the at least one sensor node and retransmit the sensed condition within a second data signal in a wireless low-power long range communication mode; and
a networked gateway configured to receive the sensed condition from the relay node and transmit the sensed condition according to internet protocol.

2. The data communication system of claim 1, wherein the wireless short-range mode is non-interfering with the wireless low-power long range communication mode.

3. The data communication system of claim 1 or 2, wherein the at least one sensor node is located in proximity of the relay node.

4. The data communication system of claim 3, wherein the at least one sensor node is located less than 100 meters from the relay node.

5. The data communication system of any one of claims 1 to 4, wherein the first data signal transmitted in the wireless short range mode has a power less than 10 dBm.

6. The data communication system of any one of claims 1 to 5, wherein the at least one sensor node comprises a plurality of sensor nodes; and
wherein the relay node is configured to receive conditions sensed the sensor nodes within a plurality of second data signals transmitted in the wireless short range mode and to retransmit the sensed conditions within the first data signal.

7. The data communication system of claim 6, wherein the plurality of sensor nodes are located in proximity of one another and the plurality of conditions sensed by the sensor nodes are related to a single tracked asset.

8. The data communication system of claim 7, wherein the networked gateway is configured to receive the plurality of sensed conditions and transmit the sensed conditions according to internet protocol to a central node configured to determine a status of the tracked asset based on the sensed conditions.

9. The data communication system of any one of claims 1 to 8, wherein the low-power long range communication mode is a long range internet-of-things protocol.

10. The data communication system of any one of claims 1 to 9, wherein the wireless short range mode is chosen from FSK, MSK, GFSK, GMSK or BLE.

11. The data communication system of any one of claims 1 to 10, wherein the relay node comprises:
a first electronic chip configured to receive and demodulate the second data signal from the wireless short range mode; and
a second electronic chip configured to modulate the sensed condition to the low-power long range communication mode and transmit the modulated signal as the first data signal.

12. The data communication system of claim 11, wherein the relay node is further configured to adjust a power of the transmitted first data signal.

13. The data communication system of claim 11 or 12, wherein the relay node is further configured to transmit a control signal in the wireless short range mode to the at least one sensor node.

14. The data communication system of any one of claims 11 to 13, wherein the relay node further comprises an embedded sensor configured to sense a condition in proximity of the relay node.

15. The data communication system of claims 1 to 14, wherein the relay node is second-layer node and wherein the system further comprises a first-layer node configured to:
receive the second data signal from the relay node transmitting in the wireless low-power long range communication mode; and
retransmit the sensed condition within a third data signal in the wireless low-power long range communication mode;
wherein the networked gateway receives the sensed condition within the third data signal from the first-layer collector node.

16. The data communication system of claim 15, wherein the second-layer node includes a plurality of second-layer nodes each transmitting in the wireless low-power long range communication mode a second data signal having a sensed condition; and
wherein the first-layer node is configured to receive the plurality of second data signals, aggregate the sensed conditions of the first data signals, and retransmit the aggregated sensed conditions within a third data signal in the wireless low-power long range communication mode.

17. The data communication system of claim 15 or 16, wherein the first-layer node is configured to receive the second data signal at a distance greater than 10 km from the second-layer node; and
wherein the networked gateway is configured to receive the third data signal at a distance greater than 10 km from the first-layer collector node.

18. The data communication system of any one of claims 15 to 17, wherein the first-layer node is within line of sight of the networked gateway.

19. The data communication system of claim 18, wherein the second-layer node is not within line of sight of the networked gateway.

20. The data communication system of any one of claims 15 to 19, wherein the first-layer node is located at an elevated position.

21. The data communication system of claim 20, wherein the first-layer node is located atop a city building.

22. The data communication system of any one of claims 1 to 21, wherein the at least one sensor node comprises a first sensor node configured to detect a geographic position of the sensor node as its sensed condition and a second sensor node configured to receive telemetric data from a vehicle black box as its sensed condition;
wherein the second sensor node, the first sensor node and the relay node are positioned on a motorized vehicle; and
wherein the sensed conditions are transmitted by the networked gateway to a central node configured to determine a status of the motorized vehicle.

23. The data communication system of any one of claims 1 to 21, wherein the at least one sensor node comprises a given sensor node configured to read an identifying code of a remotely-readable identification tag located in proximity of the given sensor node as its sensed condition; and
wherein the relay node is located in geographic proximity of the given sensor node; and
wherein the identifying code is transmitted by the networked gateway to a central node configured to determine a presence of an object bearing the remotely-readable identification tag at a known location of the given sensor node.

24. The data communication system of claim 23, wherein the embedded sensor of the second-layer collector node is a presence detector configured to detect the presence of an object in proximity of the second-layer collector node as its sensed condition;
wherein the at least one sensor node comprises a second sensor node configured to read a second identifying code of a second remotely-readable identification tag located in proximity of the second sensor node as its sensed condition; and
wherein the detected presence and the second identifying code are transmitted by the networked gateway to a central node configured to determine a presence of the object in proximity of the second-layer collector node and an identification code of the object.

25. The data communication system of claim 24, wherein the embedded sensor of the relay node is a magnetometer.

26. The data communication system of any one of claims 1 to 21, wherein the at least one sensor node comprises a given sensor node configured to detect a position of the given sensor node relative to external reference nodes defining a localized area as its sensed condition;
wherein the relay node is located in geographic proximity of the given sensor node; and
wherein the position is transmitted by the networked gateway to a central node configured to track a position of an object bearing the given sensor node within the defined localized area.

27. The data communication system of any one of claims 1 to 21, wherein the at least one sensor node comprises a given sensor node detect an operating mode of a piece of equipment as its sensed condition;
wherein the relay node is located in geographic proximity of the given sensor node; and
wherein the operating mode is transmitted by the networked gateway to a central node configured to track a status of the geographic location of the relay node based on the operating mode of the piece of equipment.

28. The data communication system of claim 27, wherein the piece of equipment is a snow removal vehicle and the operating mode is chosen from one or more of traveling, removing snow, salting, spreading road abrasives; and
wherein the status of the geographic location of the second-layer collector node is chosen from one or more of snow clear, road salted, and abrasives spread.

29. The data communication system of claim 27, wherein the piece of equipment is a garbage removal vehicle or recycling vehicle and the operating mode is chosen from removal of garbage or removal of recycled materials; and
wherein the status of the geographic location of the second-layer collector node is chosen from one or more of garbage removed and recycling removed.

30. A data communication system comprising:
a plurality of second-layer nodes configured to transmit a plurality of sensed conditions within a plurality of data signals in a wireless low-power long range communication mode; and
a first-layer node configured to receive the data signals from the second-layer collector nodes, aggregate the sensed conditions of the received data signals, and retransmit the aggregated sensed conditions within an additional data signal in the wireless low-power long range communication mode; and
a networked gateway configured to receive the sensed conditions from the first-layer collector node and transmit the sensed conditions according to internet protocol.

31. The data communication system of claim 30, wherein each of the plurality of second-layer nodes is configured to transmit at least one sensed condition within at least one data signal in the wireless low-power long range communication mode; and
wherein the data signals received at the first-layer node comprises the at least one data signal transmitted from each of the second layer nodes.

32. The data communication system of claim 30 or 31, wherein the first-layer node is configured to receive the data signals from the plurality of second-layer nodes at a distance greater than 10 km from the second-layer collector nodes; and
wherein the networked gateway is configured to receive the additional data signal at a distance greater than 10 km from the first-layer node.

33. The data communication system of any one claims 30 to 32, wherein at least one of the second-layer nodes receives a sensed condition from a sensor node having a sensor device adapted to sense the condition.

34. The data communication system of any one of claims 30 to 33, wherein at least one of the second-layer nodes comprises an embedded sensor adapted to sense the condition.

35. The data communication system of claims any one of claims 30 to 34, wherein the first-layer node is within line of sight of the networked gateway.

36. The data communication system of claim 33, wherein the second-layer node is not within line of sight of the networked gateway.

37. The data communication system of any one of claims 30 to 36, wherein the first-layer node is located at an elevated position.

38. The data communication system of claim 37, wherein the first-layer node is located atop a city building.

39. The data communication system of claim 38, wherein the second-layer node is located at ground level.

40. The data communication system of any one of claims 30 to 39, wherein the first-layer collector node comprises a directional antenna directed at the networked gateway, the additional data signal being transmitted by the directional antenna.

41. The data communication system of any one of claims 30 to 40, wherein the wireless low-power long range communication mode is a long range internet-of-things protocol.

42. The data communication system of any one of claims 30 to 41, wherein the first-layer collector nodes comprises:
a first electronic chip configured to receive and demodulate the wireless low-power long range communication mode the data signals received from the plurality of second-layer collector nodes;
a microcontroller configured to aggregate the sensed conditions from the demodulated data signals; and
a second electronic chip configured to modulate the aggregated sensed conditions to the low-power long range communication mode and transmit the modulated signal as the additional data signal.

43. The data communication system of any one of claims 30 to 42, wherein the second-layer node comprises an embedded sensor configured to detect the presence of an object in proximity of the second-layer collector node, the detected presence being transmitted as its sensed condition within a data signal in a wireless low-power long range communication mode; and
wherein the detected presence is transmitted by the networked gateway to a central node configured to determine a presence of the object in proximity of the second-layer collector node.

44. A signal communication device comprising:
a first electronic chip configured to receive first data signals from a plurality of sensor nodes in a wireless short range mode and to demodulate the second data signals; and
a second electronic chip configured to remodulate the demodulated first data signals to a low-power long range communication mode and transmit the remodulated signals as a second data signal.

45. The signal communication device of claim 44, wherein the wireless short range mode is non-interfering with the wireless low-power long range communication mode.

46. The signal communication device of claim 44 or 45, wherein the low-power long range communication mode is a long range internet-of-things protocol.

47. The signal communication device of any one of claims 44 to 46, wherein the wireless short range mode is chosen from FSK, MSK, GFSK, GMSK or BLE.

48. The signal communication device of any one of claims 44 to 47, wherein the second electronic chip is further configured to adjust a power of the transmitted first data signal.

49. The signal communication device of any one of claims 44 to 48, further comprising a microcontroller configured to transmit a control signal in the first wireless mode to at least one of the sensor nodes.

50. The signal communication device of any one of claims 44 to 49, further comprising an embedded sensor configured to sense a condition in proximity of the device and wherein the second electronic chip is further configured to modulate the sensed condition and transmit it within the second data signal.
